(19) United States
(12) Patent Application Publication
(10) Pub. No.: US 2026/0085859 A1
(43) Pub. Date: Mar. 26, 2026

(54) DETECTION METHOD FOR MEASURING PROFILE ACCURACY OF PARABOLIC TROUGH REFLECTORS AND DETECTION DEVICE THEREOF

(71) Applicant: HARBIN QINGYUFENG TECHNOLOGY CO., LTD., Harbin (CN)

(72) Inventor: Haifeng LUAN, Harbin (CN)

(21) Appl. No.: 19/277,346

(22) Filed: Jul. 22, 2025

Related U.S. Application Data
(63) Continuation of application No. PCT/CN2025/088193, filed on Apr. 10, 2025.

(30) Foreign Application Priority Data
Sep. 20, 2024 (CN) 2024113160892

(51) Int. Cl. F24S 23/74; G01B 11/06

(52) U.S. Cl. CPC F24S 23/74; G01B 11/06

(57) ABSTRACT

A measurement method and a measurement device for profile accuracy of parabolic trough reflector are provided, which solves the problem of existing technology relying on the final assembly plant for detection and the inability to detect on the final application site, as well as the high requirements of existing optical detection device for the plant. The method and device of the present disclosure use light emitted from a light source to simulate the light emitted from the focal point of a parabolic reflector to be detected, then emitting onto the parabolic reflector to be detected. The shape and position accuracy of the parabolic reflector to be detected are measured based on the deviation of the reflected light, and it no longer rely on the final assembly plant and can detect the final profile accuracy of parabolic reflectors on the application site or after regular operation, significantly reducing costs.

### CROSS-REFERENCE

This application is a continuation of International Application No. PCT/CN2025/088193 with a filling date of Apr. 10, 2025, designating the United states, now pending, and further claims to the benefit of priority from Chinese Application No. 202411316089.2 with a filing date of Sep. 20, 2024. The content of the aforementioned applications, including any intervening amendments thereto, are incorporated herein by reference.

### TECHNICAL FIELD

The present disclosure relates to a detection method and detection device for measuring complex surface profiles, belonging to the technical field of precision detection of solar reflectors.

### BACKGROUND

The trough solar thermal power generation system uses parabolic trough reflectors to concentrate heat and generate electricity. It mainly consists of parabolic trough reflectors, heat collection tubes, and tracking mechanisms, wherein the reflector is generally made of glass, with silver plated and coated with a protective layer on the back, and the reflector can also be made of mirror aluminum plate or mirror stainless steel plate. The parabolic trough reflector can focus the incident sunlight onto a line at the focal point, and a heat collection tube with a receiver is installed on this line to absorb sunlight to heat the internal heat transfer medium.

In the entire trough solar thermal power generation system, the profile accuracy of the parabolic surface of the reflector is very important, as it can determine the reflection effect of sunlight. When the profile accuracy of the parabolic surface of the reflector is low, the sunlight reflected by the reflector cannot be effectively focused on the heat collection tube at the focal point of the parabolic trough reflector, reducing the total effective area of the reflector and directly leading to a decrease in the thermal efficiency of the entire power generation system. Therefore, whether it is the factory inspection of the parabolic reflector or the surface accuracy inspection of the parabolic reflector on the solar thermal power generation site, it is extremely important.

The existing surface accuracy detection technology for parabolic reflectors is to install optical detection device on the roof of the final assembly plant, place the assembled parabolic reflector under the optical detection device, use the optical detection device to receive the reflection of light by the reflector, and then measure and detect the surface accuracy of the parabolic reflector.

In the existing patents, the patent with patent No. 201210004029.8 discloses a rapid performance evaluation device and method for solar energy accumulation reflection mirror surface. It discloses a gantry frame, a crossbeam, and a light target bracket. Linear guide rails are installed on both sides of the gantry frame, and the two ends of the crossbeam cooperate with the two linear guide rails in sliding manner. The crossbeam is driven by a driving motor and a transmission mechanism to move vertically up and down on the gantry frame. A plurality of small laser tubes are installed in parallel at equal intervals on the crossbeam to simulate the convergence of parallel sunlight emitting onto the reflection mirror surface. The light target bracket is installed in the middle of the crossbeam, and a light target and a CCD camera are installed on the bracket. The CCD camera is used to obtain the image of the reflection mirror surface emitting onto the light target, then the obtained image is converted to digital video signals, and the digital video signals are performed image processing and analysis by PC to evaluate the performance of reflecting mirror.

However, the existing technology has the following problems: 1. The detection of the profile accuracy of parabolic reflector surfaces must be carried out in the final assembly plant, and it is not possible to perform final installation status detection on the application site of parabolic reflectors. It is also impossible to perform on-site detection and calibration of profile accuracy of parabolic reflectors after a period of operation or regular maintenance. Moreover, the common size of parabolic reflector openings is 5 to 12 meters long, and the length range of parabolic reflectors is generally 8 to 18 meters, which is not convenient for storage and transportation and is difficult to measure; 2. The existing technology has high requirements for factory buildings, and optical detection device and post-processing device are expensive and complex; 3. The disclosure (Patent No. 201210004029.8) discloses a rapid performance evaluation device and method for solar energy accumulation reflection mirror. In this disclosure of detection technology, the relative position between the entire gantry frame and the parabolic reflector to be detected cannot be effectively determined, resulting in the need to adjust the light target during each detection, to set the light target at the focal point of the parabolic reflector, making the detection process cumbersome, in addition, due to structural limitations, the device cannot be effectively applied to the on-site detection of parabolic reflectors; moreover, the device uses a single light target to collect images of multiple laser tubes reflected by reflectors. Although it can detect the overall performance of parabolic reflectors, the CCD camera can only collect images on the light target and cannot collect the light reflection path. Therefore, it cannot be determined which specific laser tube has an error in the location of its reflected image, resulting that it is unclear which specific location of the parabolic reflector has a surface defect, that can not provide guidance for the production process of parabolic reflectors (such as whether there is a mold position or process defect that causes the surface defect at that point).

Therefore, it is urgent to propose a new measurement method and a measurement device for profile accuracy of parabolic trough reflector to solve the above technical problems.

### SUMMARY

The objective of the present disclosure is to solve the problem that the surface accuracy of the existing parabolic trough reflector can only be detected in the factory building, and cannot be measured after final installation, operation, and maintenance on the application site, as well as the problem that the existing optical detection device for detecting in the factory building is expensive and complex, which requires high cost for the factory building. Therefore, a detection method and a detection device for measuring profile accuracy of parabolic trough reflector are invented. The following text provides a brief overview of the present disclosure in order to provide a basic understanding of certain aspects of the disclosure. It should be understood that this summary is not an exhaustive overview of the present disclosure, and it is not intended to determine the key or essential parts of the present disclosure, nor is it intended to limit the scope of the present disclosure.

The technical solution of the present invention:

A detection method for measuring profile accuracy of parabolic trough reflectors, including the following steps:
Step S1, using lights emitted by a light source to simulate lights emitted from a focal point of a parabolic reflector to be detected, and emitting onto the parabolic reflector to be detected;
Step S2, measuring a shape and a position accuracy of the parabolic reflector to be detected based on a deviation of a reflected light reflected by the parabolic reflector.

Preferably, there are at least two light sources, and the light sources emit parallel light rays that intersect at the intersection point and then emitting onto the parabolic reflector surface to be detected, or reverse extension lines of the parallel light rays emitted by the light sources intersect at the intersection point.

Preferably, the position relationship between the light source and the parabolic reflector to be detected is that a plane formed by the light source and the parallel light rays and a cross-sectional profile of the parabolic reflector to be detected are in the same plane, and the intersection point of all parallel light rays coincides with the focal position of the parabolic reflector to be detected.

Preferably, in step S2, the specific method for measuring the shape and the position accuracy of the parabolic reflector to be detected includes calibrating and checking the parallelism of the parallel light rays reflected by the parabolic reflector from the light source and/or the position error of light spots formed by a projection of the parallel light rays, thereby measuring a position deviation and an angle deviation of the parabolic reflector to be detected.

A detection device for measuring the profile accuracy of parabolic trough reflectors includes at least two light sources for emitting parallel light rays and a scale, the positions of the light sources and the scale are relatively fixed, and the parallel light rays emitted by the light sources are incident on the parabolic reflector to be detected for reflection, forming a light spot on the scale.

Preferably, the scale is provided with a scale dial, and the scale dial is provided with a scale line with two-dimensional coordinate, and the number and position of the scale dial correspond one-to-one with the number and position of light spots formed by parallel light rays emitting on the scale.

Preferably, the scale is a foldable, extendable, or/and detachable structure.

Preferably, the scale adopts a scale dial with a photosensitive surface, and the scale dial converts the position of the light spots emitting on the surface into electrical signals.

Preferably, a slider is installed on the detection device, a sliding rail is provided as a support structure on a heat collection tube bracket of the parabolic reflector surface to be detected, and the slider on the detection device is used in conjunction with the sliding rail provided on the heat collection tube bracket.

Preferably, the slider is adjustably installed on the scale through a first adjustment bolt.

Preferably, two light source supports in parallel are installed on the lower end face of the scale, and slide adjustment seats are respectively installed on inner sides of the light source supports, and the slider is installed on the slide adjustment seat through the first adjustment bolt.

Preferably, two light source supports in parallel are installed on the lower end face of the scale, the second adjustment bolt is installed on the light source support, and the second adjustment bolt abuts against the sliding rail.

Preferably, the light source support is provided with a light source installation hole, and the light source is installed in the light source installation hole.

Preferably, the first identification part is provided at the center of the lower end face of the scale.

Preferably, the first identification part is provided at the center of the lower end face of the scale, a positioning support is installed at the lower end of the sliding rail, and the second identification part corresponding to the first identification part is installed at the center of the positioning support.

Preferably, the end of the first identification part is arc-shaped, and when used for detection, the first identification part is in contact with the outer wall of the heat collection tube.

Preferably, the first identification part and the second identification part are both triangles, or the first identification part is a triangle and the second identification part is an M-shape matching the triangle of the first identification part.

The present disclosure has the following advantageous effects:

The detection method and detection device for measuring and detecting the profile accuracy of parabolic trough reflectors of the present disclosure is to simulate setting a light source at the focal point of the parabolic reflector, and detecting the profile accuracy of the parabolic reflector by detecting the parallel light error reflected by the light emitted from the light source towards the parabolic reflector. This method and device do not rely on the final assembly plant, and can detect the accuracy of the final application status of the parabolic reflector in the heat collector application site, as well as perform regular inspections after a period of operation. Compared with existing technologies, it significantly reduces costs, and the detection results are simple and intuitive. The detection results and calibration targets are formed on the spot, solving the problem of expensive, complex, and inability to detect the final operation status of parabolic reflectors in existing technologies.

### BRIEF DESCRIPTION OF THE DRAWINGS

FIG. 1 is a schematic diagram of the parabolic reflector for focusing and collecting heat in Embodiment 1;

FIG. 2 is a schematic diagram of the overall structure of a trough heat collector in Embodiment 1;

FIG. 3-1 is the first schematic diagram of the method for detecting parallel light rays at the reflection focus of a parabolic trough in Embodiment 1 and Embodiment 2;

FIG. 3-2 is the second schematic diagram of the method for detecting parallel light rays at the reflection focus of a parabolic trough in Embodiment 1 and Embodiment 2;

FIG. 4-1 is the first schematic diagram showing the plan view of the structure of an accuracy detection device for parabolic trough reflector;

FIG. 4-2 is the second schematic diagram of the structure of the accuracy detection device for parabolic trough reflector;

FIG. 5 is a schematic diagram of the arrangement structure of the scale dial on the scale;

FIG. 6 is a schematic diagram of the x-axis direction detection deviation of the parabolic reflector in Embodiment 1;

FIG. 7 is a schematic diagram of the z-axis direction detection deviation of the parabolic reflector in Embodiment 1;

FIG. 8 is a schematic diagram of the detection deviation in both the x-axis and z-axis directions of the parabolic reflector in Embodiment 1;

FIG. 9 is a schematic diagram of the installation structure of the sliding rail on the heat collection tube bracket in Embodiment 5;

FIG. 10 is the schematic diagram of the installation alignment between the detection device and the sliding rail in Embodiment 6;

FIG. 10-1 is a schematic diagram of the installation of the scale on the heat collection tube bracket in Embodiment 9;

FIG. 11 is the installation structure and positional relationship of the second identification part, the positioning support, and the sliding rail in Embodiment 10;

FIG. 12 is a schematic diagram of the structure of the combined detection device in Embodiment 11.

Reference labels in the figures: 1—parabolic reflector, 2—reflector support, 3—heat collection tube, 4—heat collection tube bracket, 5—light source, 6—parallel light ray, 7—scale, 8—slider, 9—sliding rail, 10—first adjustment bolt, 11—second adjustment bolt, 12—positioning bolt, 13-1 first identification part, 13-2 second identification part, 14—light source support, 15—installation positioning hole, 17—first detection device, 18—second detection device, 19—slider adjustment seat, 20—intersection point, 21—positioning support, 71—scale dial, 711—scale line, 712—origin point of scale dial.

### DETAILED DESCRIPTION OF THE EMBODIMENTS

In order to clarify the objective, technical solution, and advantages of the present disclosure, the specific embodiments shown in the accompanying drawings will be described below. However, it should be understood that these descriptions are merely exemplary and not intended to limit the scope of the disclosure. Furthermore, in the following description, descriptions of well-known structures and techniques have been omitted to avoid unnecessary confusion of the concepts of the present disclosure.

The present disclosure is a method and device for detecting the profile accuracy of parabolic reflector surfaces, which solves the problems that the profile accuracy of parabolic reflector surfaces cannot be detected on the final application site due to relying on final assembly plant for profile accuracy detection of parabolic reflectors in existing technologies, as well as the high requirements of expensive and complex optical detection device for plants.

The method and device of the present disclosure use a light source 5 to simulate the focal point of a parabolic reflector 1, and detect the parabolic surface accuracy of the parabolic reflector by measuring the error of the light incident on the parabolic reflector 1 and the reflected parallel light.

The method and device of this disclosure no longer rely on the final assembly plant, and can detect the final profile accuracy of parabolic reflector 1 at the final application site or after regular operation, greatly reducing costs. The detection and measurement results are simple and intuitive, and can form detection results and calibration targets on the spot, solving the problems of existing technology.

### Embodiment 1

Firstly, for the convenience of description, the illustrations of the present disclosure are all made in a three-dimensional rectangular coordinate system of x, y, and z.

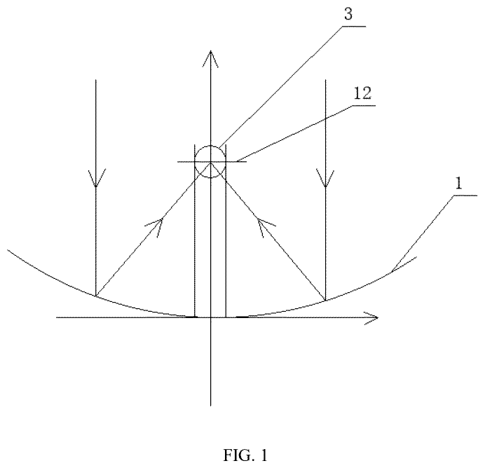

This embodiment is a detection method for the profile accuracy of a parabolic trough reflector. As shown in FIG. 1, the trough heat collector is used to collect parallel light from solar energy irradiation. The parallel light is collected and focused onto a heat collection tube 3 located at the focal line of the parabolic reflector 1 through the parabolic reflector 1, achieving the effect of collecting solar energy.

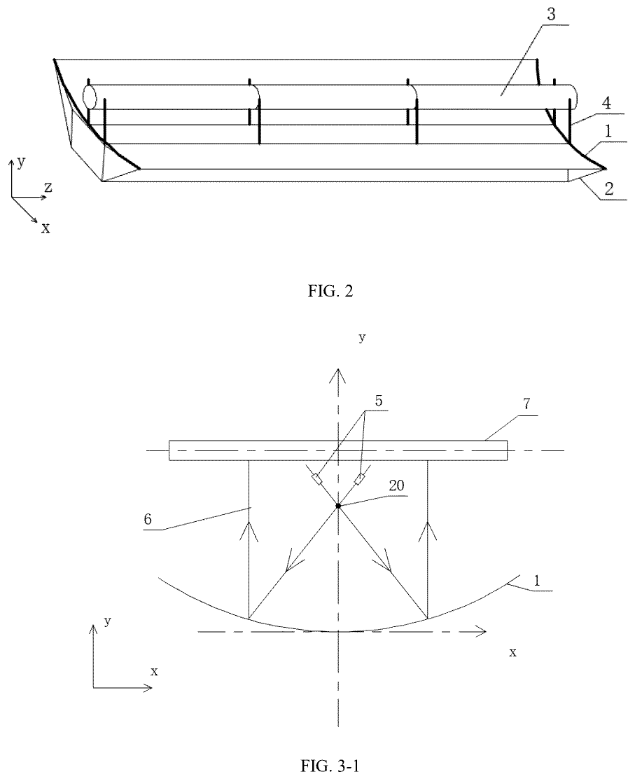

As shown in FIG. 2, the trough heat collector includes a parabolic reflector 1, a reflector support 2, a heat collection tube 3, and a heat collection tube bracket 4. The parabolic reflector 1 is mounted on the reflector support 2, the heat collection tube 3 is mounted on the heat collection tube bracket 4, and the heat collection tube 3 is located at the focal point of the parabolic reflector 1.

For this trough heat collector, the detection method for the profile accuracy of parabolic trough reflectors in this embodiment, as shown in FIG. 3-1 and FIG. 3-2, specifically includes the following steps:
Step 1. base on the light emitted by light source 5, simulating the light emitted from the focal point of the parabolic reflector 1 to be detected, and emitting the light onto the parabolic reflector 1 to be detected;
Step 2. detecting the shape and position accuracy of the parabolic reflector 1 to be detected according to the light deviation reflected by the parabolic reflector 1 to be detected.

In this embodiment, the light source 5 is used to simulate the lights emitted from the focal point of the parabolic reflector 1 to be detected, the lights are emitting onto the parabolic reflector 1 to be detected and reflect parallel light rays 6 parallel to the y-axis. Then, according to the parallelism error of the parallel light rays 6 and/or the position error of the parallel light spots, the profile accuracy of the parabolic reflector 1 is detected.

The lights emitted by light source 5 are high brightness parallel light rays 6, which does not scatter. After being reflected by the parabolic reflector 1 to be detected, the light ray of the parallel light rays 6 are emitting on the scale 7 to generate light spots, and the diameter of the light rays or light spots is less than 2 mm.

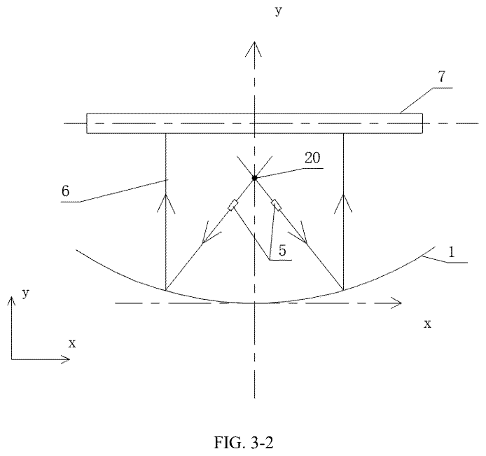

There are at least two light sources 5. As shown in FIG. 3-1, the parallel light rays 6 emitted by the light sources 5 are reflected on the parabolic reflector 1 to be detected after intersecting at the intersection point 20. Or, as shown in FIG. 3-2, the reverse extension lines of the parallel light rays 6 emitted by the light sources 5 intersect at the intersection point 20.

Furthermore, the positional relationship between the light source 5 and the parabolic reflector 1 to be detected is that the plane formed by the light source 5 and its parallel light rays 6 is on the same plane as the profile of the cross-section of the parabolic reflector 1 to be detected, and the intersection point 20 of all parallel light rays 6 coincides with the position of the focal point of the parabolic reflector 1 to be detected. In this way, the light source 5 can simulate the lights emitted from the focal point of the parabolic reflector 1 to be tested. The parallel light rays 6 emitted through the light source 5 can reflect after passing through the cross-section of the parabolic reflector 1 to be detected. As the light source 5, the parallel light rays 6, and the cross-section of the parabolic reflector 1 to be detected are all in the same spatial plane, the detection of the profile accuracy of the parabolic trough reflector can be completed by determining the parallelism of the parallel light rays 6 or the difference between the position of the light spots formed by the projection of the parallel light rays 6 and the standard position.

Further, in step 2, the specific method for detecting the shape and position accuracy of the “parabolic reflector 1 to be detected” is to calibrate and check the “parallelism of the parallel light rays 6 reflected by the light source 5 through the parabolic reflector 1 to be tested” or/and the “position error of the light spots formed by the projection of the parallel light rays 6”, and the position and angular deviation of the parabolic reflector 1 to be detected are measured.

In this embodiment, the detection method for the profile accuracy of the parabolic trough reflector is as follows:

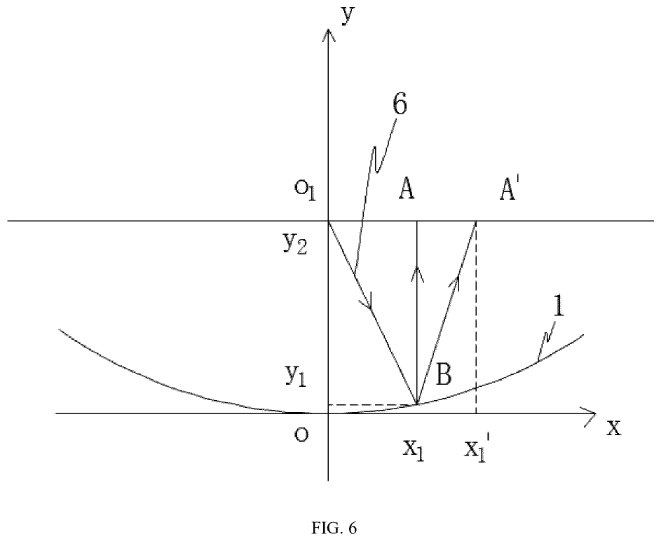

As shown in FIG. 6, the parallel light rays 6 emitted by the light source 5 (0₁ point) are reflected to the point B on the parabolic reflector 1 to be detected. If the coordinates of point B is (x₁, y₁, z₀), the coordinate value and the tangent angle of point B satisfy the parabolic equation of the reflector: x²=2 py, for the standard parabolic reflector 1 to be detected, the parallel light rays 6 reflected by point B is parallel to the y-axis. After reflection, the coordinates of any point on the parallel light rays 6 are x=x₁, z=z₀. If the scale 7 of the detection device is at y=y₂ and the scale 7 is parallel to the x-axis, then the standard spot position coordinate A of the parallel light rays 6 from the light source 5 reflected by point B emitting onto the scale 7 is (x₁, y₂, z₀).

If there is a positional or/and tangent angle deviation of point B of the parabolic reflector 1 to be detected in the xy plane, it will be reflected to the coordinate (x₁′, y₂, z₀) of the point A′ shown in FIG. 6. A deviation of Δx=x₁′−x₁ is generated between that light spot of the light source and the standard position A in the x axis, which means that point B has a deviation in the xy plane, accordingly adjusting the xy direction angle of point B in the parabolic reflector 1 to be detected, so that Δx can be reduced to the specified error requirement range.

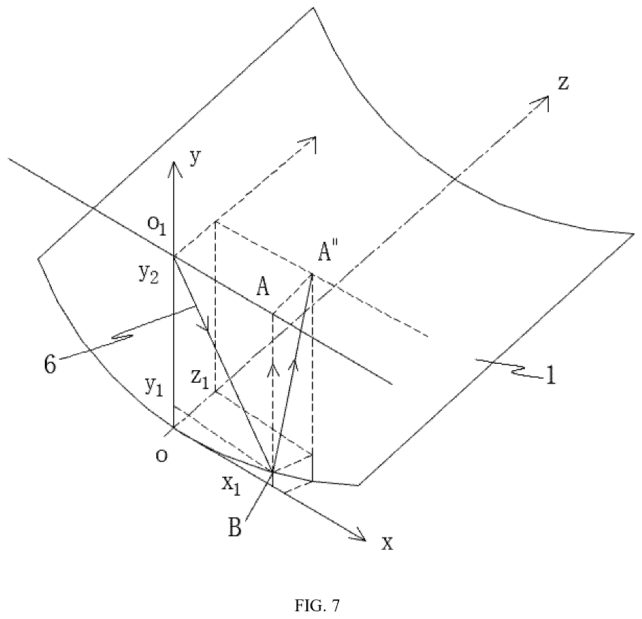

As shown in FIG. 7, if the position of the light spot of parallel light rays 6 refracted to the scale height y₂ plane through point B is A″ (x₁, y₂, z₁) and there is a position deviation Δz=z₁−z₀ in the Z axis direction between the standard position A (x₁, y₂, z₀) and A″ (x₁, y₂, z₁), it means that point B has a deviation in the yz plane, accordingly adjusting the angle in the yz direction of point B of the reflector can reduce Δz to the specified error requirement range.

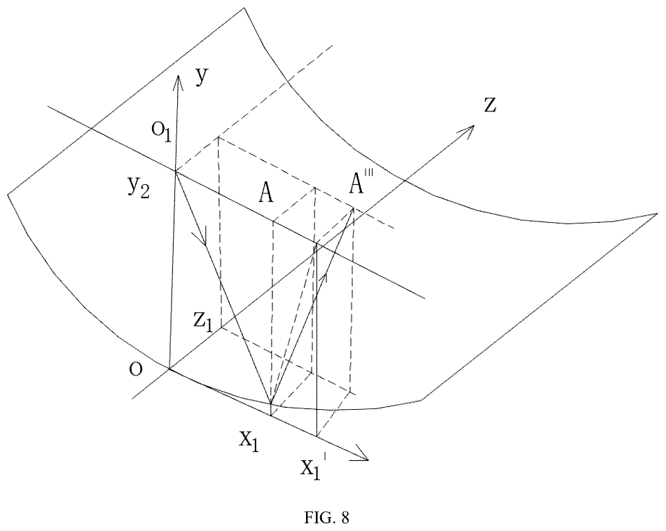

As shown in FIG. 8 , if the light source ray refracts onto light A′″ (x₁, y₂, z₁) of the scale through point B of the reflector, and there is deviations in the x-axis direction and z-axis direction from the standard position A, it indicates that there is deviations in point B of the reflector in both the xy plane and yz plane, wherein the deviation in the x-axis is Δx=x₁′−x₁ and the deviation in z-axis direction is Δz=z₁−z₀. Based on the deviation values Δx and Δz, the profile accuracy of point B of the reflector can be calibrated, and the angle of point B can be adjusted in the xy and yz planes to reduce Δx and Δz within the specified error requirements.

By further detecting the three mirror points of a parabolic reflector 1, the deviation from the standard light spot coordinates can be obtained, and the position and angle deviation of each detection point can be calculated and measured to obtain the deviation adjustment amount for adjusting the xy, yz angle and/or height position of the entire reflector.

### Embodiment 2

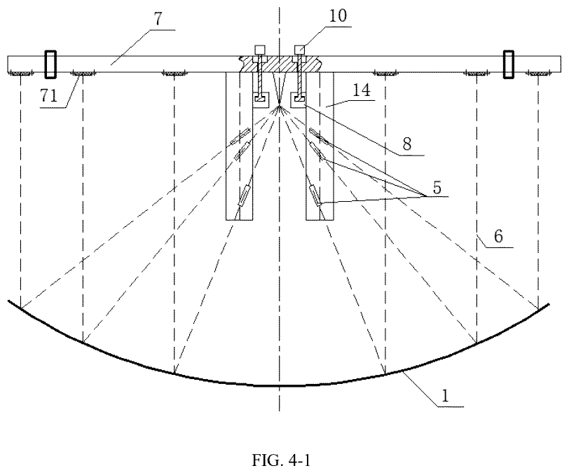

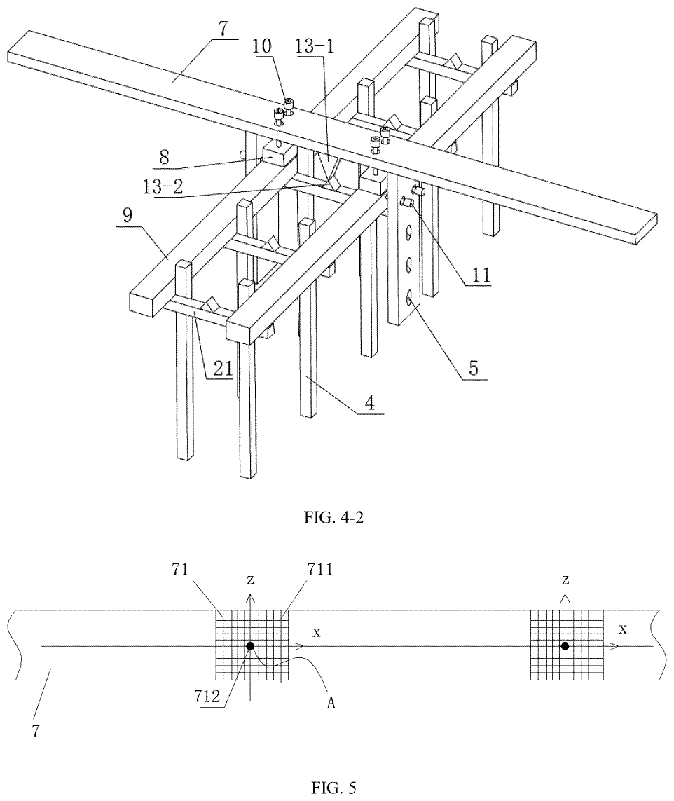

According to the detection method of embodiment 1, this embodiment 2 provides a detection device for the profile accuracy of a parabolic trough reflector, as shown in FIG. 3-1, FIG. 3-2, FIG. 4-1, FIG. 4-2, and FIG. 5. The detection device includes at least two light sources 5 for emitting parallel light rays 6 and a scale 7. The positions of the light sources 5 are relatively fixed to the scale 7. The parallel light rays 6 emitted by the light sources 5 are incident on the parabolic reflector 1 to be detected, generating reflection and illuminating the scale 7 to form a light spot;

Wherein the scale 7 is equipped with a scale dial 71. the scale dial 71 is provided with scale lines 711 with two-dimensional coordinate. The number and position of the scale dial 71 correspond one-to-one with the number and position of the light spots formed by the parallel light rays 6 emitting on the scale 7. The origin point 712 of each scale dial on the scale 7 is located at the standard position of the parallel light spots reflected by the light source rays through the standard parabolic reflector 1.

The specific method of using the detection device of this embodiment for measuring the profile accuracy of parabolic reflector is as follows: installing the scale 7 directly above the parabolic reflector 1 to be detected, and making the light source 5 emit parallel light rays 6 that intersect at the intersection point 20 and then the parallel light rays 6 are incident on the parabolic reflector 1 to be detected; or, the reverse extension line of the parallel light rays 6 emitted by the light source 5 intersects with the intersection point 20, and the parallel light rays 6 emitted by the light source 5 are used to irradiate the parabolic reflector 1 to be detected for forming reflections, and finally projecting the light spots onto the scale dial 71 of the scale 7. By using the detection method for measuring the profile accuracy of parabolic reflector in Embodiment 1, the shape and position accuracy of the “parabolic reflector 1 to be detected”can be achieved.

In the above measurement calculation method, the scale 7 set along the x-axis corresponds to the standard position of the parallel light spots reflected by the standard parabolic reflector 1 for each parallel light ray 6, which is the origin point of each scale dial 71, that is, point A shown in FIG. 5. The dial surface of the scale dial 71 is perpendicular to the y-axis, and scale lines 711 are set in parallel to the x-axis and z-axis with the origin point as the centre, to detect and mark the deviation value between the deviation spot and the standard spot, that is, the deviation value between points A′, A″, A′″ and the origin point A shown in FIGS. 6, 7, and 8.

### Embodiment 3

The difference between this embodiment 3 and embodiment 2 is that, in order to facilitate the collection of light spot position data of parallel light rays 6 reflected on the scale 7 by the parabolic reflector 1, the scale dial 71 of the scale 7 adopts a photosensitive recognition surface to convert the light spot position data during detection into electrical signals in real time and transmit them to the computer for real-time data acquisition, storage, and calculation.

### Embodiment 4

The difference between this embodiment and the aforementioned embodiment 2 and embodiment 3 is that the two sides of the scale 7 are foldable, extendable, or/and detachable structures. Due to the common size of the opening of the parabolic reflector 1 being 5-12 meters and the length of the heat collector being approximately 8-18 meters, the length of the measuring scale 7 should be equivalent to the opening size of the parabolic reflector. Therefore, the length of the scale 7 also needs to be made into 5-12 meters. However, this length of scale 7 is not convenient for storage and transportation, so it is designed as a foldable and/or detachable structure.

### Embodiment 5

As shown in FIG. 4-1 and FIG. 4-2, a slider 8 is installed on the detection device, and a sliding rail 9 is set as a support structure on the heat collection tube bracket 4 of the parabolic reflector 1 to be detected. The slider 8 on the detection device is used in conjunction with the sliding rail 9 set on the heat collection tube bracket 4.

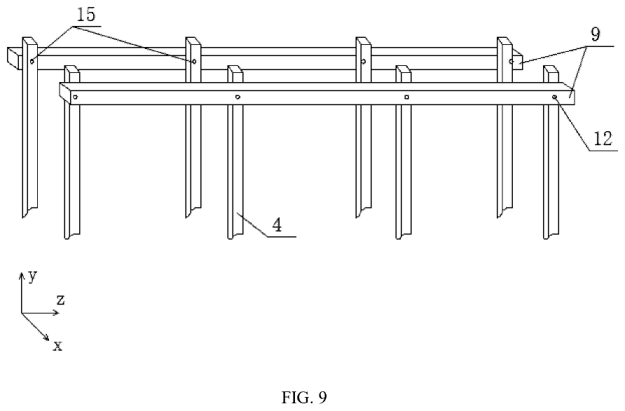

In this embodiment 5, as shown in FIG. 4-2, the slider 8 is directly adjustable and installed on the scale 7 through the first adjustment bolt 10. As shown in FIG. 9, the sliding rail 9 can be fixedly installed on the heat collection tube bracket 4 through the positioning bolt 12. Specifically, on the heat collection tube bracket 4 of the parabolic reflector 1 to be detected, the positioning bolt 12 is installed at the installation positioning hole 15 of the heat collection tube 3, and the sliding rail 9 is fixed by the positioning bolt 12. In this way, when using the detection device to measure the parabolic reflector 1 to be detected, the scale 7 is installed on the sliding rail 9 through the slider 8, and the first adjustment bolt 10 is adjusted. By adjusting the first adjustment bolt 10, the installation position of the slider 8 relative to the sliding rail 9 is adjusted, so that the “intersection point 20 of the parallel light rays 6 emitted by the light source 5” or the “intersection point 20 of the reverse extension line of the parallel light rays 6 emitted by the light source 5” on the detection device is at the focal point of the parabolic reflector 1 to be detected (or the intersection point 20 coincides with the focal point of the parabolic reflector 1 to be detected). At this time, the results of the profile accuracy measurement detection of parabolic reflectors by the method of embodiment 1 or embodiment 2 are more accurate and reliable.

### Embodiment 6

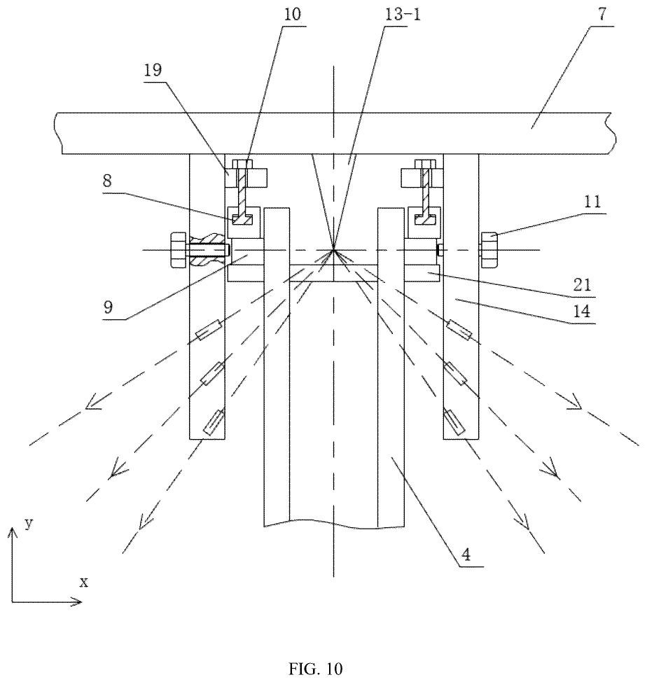

The difference between this embodiment 6 and embodiment 5 lies in the installation form of the slider 8 on the scale 7, as shown in FIG. 10, the lower end face of the scale 7 is equipped with two light source supports 14 in parallel, and the inner sides of the light source supports 14 are equipped with slider adjustment seats 19, respectively. The slider 8 is installed on the slider adjustment seat 19 through the first adjustment bolt 10. By adjusting the first adjustment bolt 10, the intersection point 20 of the light source 5 can still be adjusted to coincide with the focal point of the parabolic reflector 1 to be detected, and the final profile accuracy measurement of the parabolic reflector can be completed.

### Embodiment 7

The detection device for the profile accuracy of the trough parabolic reflectors in this embodiment 7, as shown in FIG. 4-2, FIG. 10, and FIG. 10-1, has two light source supports 14 in parallel installed on the lower end face of the scale 7. The light source supports 14 are also equipped with a second adjustment bolt 11, respectively. The second adjustment bolt 11 abuts against the sliding rail 9. By adjusting the second adjustment bolt 11 in this way, the position of the scale 7 in the z-axis direction meets the detection and installation standards, avoiding errors in the profile accuracy measurement and detection data of the parabolic reflector caused by installation errors of the scale 7.

### Embodiment 8

The detection device for the profile accuracy of the parabolic trough reflector in this embodiment 8, as shown in FIG. 4-1, FIG. 4-2, and FIG. 10, light sources 5 are mounted on a light source support 14 with a plurality of light source installation holes. A plurality of light sources 5 are installed in the light source installation holes, and the parallel light rays 6 emitted from the light sources 5 emitting on the parabolic reflector 1 to be detected for reflection, and finally the light spot is projected onto the scale dial 71 of the scale 7. Since the number of scale dial 71 on the scale 7 corresponds one-to-one with the number of light sources 5, the profile accuracy detection of the parabolic reflector 1 to be detected can be achieved by calibrating, identifying, and checking the imaging state on each scale dial 71. Through profile accuracy, it is possible to accurately analyze whether there are installation errors, surface defects, and other issues with the parabolic reflector 1 to be detected. In addition, due to the one-to-one correspondence between the scale dial 71 and the light source 5 in this embodiment, the detection results on the scale dial 71 can be used to infer which light source 5 has a surface defect on the surface of the parabolic reflector 1 to be detected, and the result data can be used to guide the production or installation of parabolic reflectors.

### Embodiment 9

The detection device for the profile accuracy of the parabolic trough reflector in this embodiment 9, as shown in FIG. 10-1, is equipped with a first identification part 13-1 at the center of the lower end face of the scale 7. The end of the first identification part 13-1 is arc-shaped, and when used for detection, the first identification part 13-1 is in contact with the outer wall of the heat collection tube 3. When setting up in this way for final installation status detection or regular maintenance after running on the photoelectric heating site for a period of time, the heat collection tube 3 has already been installed on the heat collection tube bracket 4. During the detection, the scale 7 is installed above the parabolic reflector 1 to be detected, and the light source support 14 is erected on both sides of the heat collection tube bracket 4. Adjusting the first adjustment bolt 10 to ensure that the sliders 8 on both sides are in contact with the sliding rails 9, and at the same time ensure that (1) the scale 7 is parallel to the x-axis; (2) the end of the first identification part 13-1 is in contact with the outer wall of the heat collection tube 3, adjusting the second adjustment bolt 11 to ensure that the position of the scale 7 in the z-axis direction meets the detection and installation standards, at this time, the intersection point 20 of the light source 5 on the light source support 14 is at the focal point of the parabolic reflector 1 to be detected. By using the method of embodiment 1 or embodiment 2, the shape and position accuracy of the “parabolic reflector 1 to be detected” can be measured and detected.

By using the first identification part 13-1 of this embodiment, it is possible to quickly and accurately complete the standard installation of the scale 7 during the detection process without disassembling the heat collection tube 3, saving manpower and material resources while significantly reducing the cost of disassembling the heat collection tube 3 for on-site maintenance. The detection results are intuitive, and the detection results and calibration targets can be formed on the spot.

### Embodiment 10

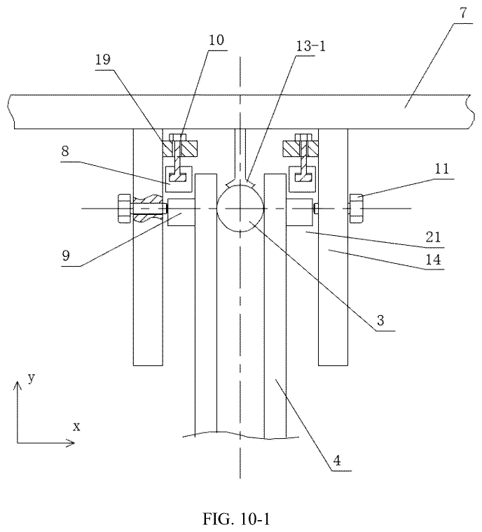

The detection device for the profile accuracy of the parabolic trough reflector in this embodiment 10, as shown in FIG. 4-2, FIG. 10, and FIG. 11, is equipped with a first identification part 13-1 at the center of the lower end face of the scale 7, a positioning support 21 installed at the lower end of the sliding rail 9, and a second identification part 13-2 corresponding to the first identification part 13-1 installed at the center of the positioning support 21. The first identification part 13-1 and the second identification part 13-2 are both triangles, or the first identification part 13-1 is a triangle and the second identification part 13-2 is an M-shape corresponding to the triangle. In this setting, during the factory production or on-site installation of trough solar collectors, if the heat collection tube 3 has not yet been installed on the heat collection tube bracket 4, during the detection, the scale 7 is installed above the parabolic reflector 1 to be detected, and the light source brackets 14 are set on both sides of the heat collection tube bracket 4. The first adjustment bolt 10 is adjusted to ensure that the sliders 8 on both sides are in contact with the sliding rails 9, and at the same time ensure that (1) the scale 7 is parallel to the x-axis; (2) the end of the first identification part 13-1 is in contact with the second identification part 13-2; the second adjustment bolt 11 is adjusted to ensure that the position of the scale 7 in the z-axis direction meets the detection and installation standards. At this time, the intersection point 20 of the light source 5 on the light source support 14 is at the focal point of the parabolic reflector 1 to be detected. By using the method of embodiment 1 or embodiment 2, the shape and position accuracy of the “parabolic reflector 1 to be detected” can be measured and detected.

As shown in FIG. 10, the detection device is installed on the temporarily installed sliding rail 9 on the heat collection tube bracket 4 of the parabolic reflector 1, so that the first identification part 13-1 and the second identification part 13-2 at the intersection point 20 of the parallel light ray 6 coincide, indicating that the parallel light ray 6 is emitted from the focal point of the parabolic reflector 1.

If the first identification part 13-1 and the second identification part 13-2 do not coincide, the position of the detection device in the y-axis direction and the angle in the xy plane are adjusted by adjusting the first adjustment bolt 10, so that the two identification structures coincide in the xy and yz planes. Further, the position of the detection device in the x-axis direction and the angle in the xz plane are adjusted by adjusting the second adjustment bolt 11, so that the two identification structures coincide in the xz plane, achieving complete alignment of the two identification structures in the xy, xz, and yz planes, completing the installation alignment of the detection device. After that, the detection of the parabolic reflector 1 to be detected can begin.

### Embodiment 11

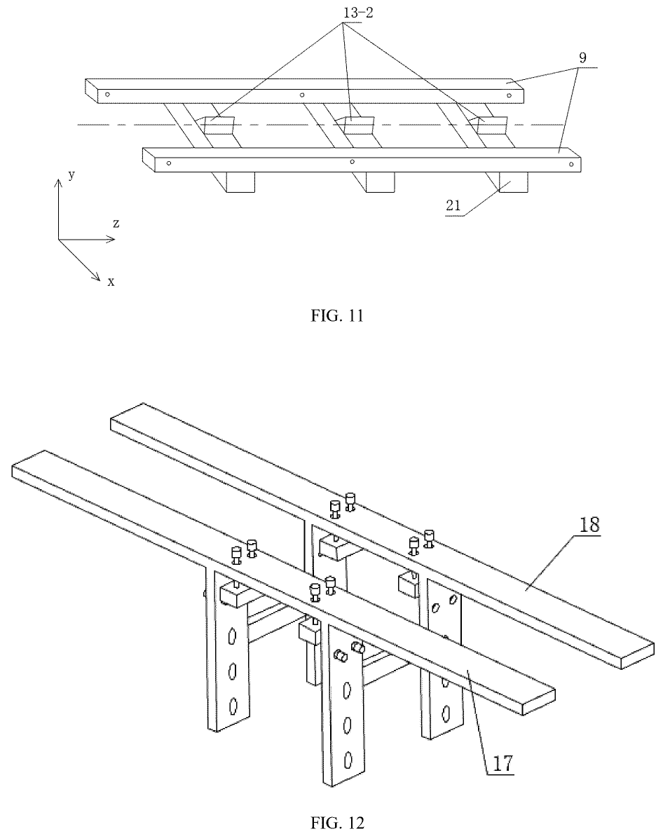

The difference between this embodiment and the previous embodiments is that, in order to improve detection efficiency, two or more sets of “detection devices” can be combined in parallel to form an integrated detection device, as shown in FIG. 12. The first detection device 17 and the second detection device 18 are connected in parallel through a connection structure, which can simultaneously detect the profile accuracy of two cross-sections of the parabolic reflector 1, improve detection efficiency, further improve detection accuracy, eliminate system measurement errors, and decouple the position deviation and surface height deviation of the reflector.

### Embodiment 12

In this embodiment, the light source (5) is a visible light source, an invisible light source, or an ultrasonic wave. The visible light source is purple light, blue light, green light, yellow light, orange light, or red light. The invisible light source is an infrared light source, ultraviolet light source, X-ray, or gamma ray.

The visible light source and the invisible light source are distinguished based on the wavelength range of light. The wavelength of light determines whether the human eye can see light, so light sources are divided into visible and invisible two types.

The first type, the visible light source, refers to the light source that emit light that can be perceived by the human eye. The wavelength range of visible light is approximately 380 to 700 nanometers, and different wavelengths correspond to different colors: (1) purple light: wavelength of about 380-450 nm; (2) blue light: wavelength of about 450-495 nm; (3) green light: wavelength of about 495-570 nm; (4) yellow light: wavelength of about 570-590 nm; (5) orange light: wavelength of about 590-620 nm; (6) red light: wavelength of about 620-700 nm. Some lasers, such as red, green, and blue lasers, can also emit specific wavelengths of visible light.

The second type, the invisible light source, refers to the light that cannot be directly seen by the human eye and have wavelengths outside the visible light range. According to different wavelengths, invisible light can be divided into the following categories: (1) Infrared light source: the wavelengths of infrared light source is greater than 700 nm, and infrared light source can be detected by some electronic devices, but cannot be seen by the human eye; (2) ultraviolet light source; (3) X-rays.

In this embodiment, the above-mentioned light source can be used in combination with embodiment 1 to achieve measurement detection of the profile accuracy of the parabolic trough reflectors.

It should be noted that in the above embodiments, as long as the technical solutions are not contradictory, they can be permuted and combined. Those skilled in the art can exhaust all possibilities based on mathematical knowledge of permutation and combination. Therefore, the present disclosure will not explain the permuted and combined technical solutions one by one, but it should be understood that the permuted and combined technical solutions have already been disclosed in the present disclosure.

The above description is only some preferred embodiments of the present disclosure and is not intended to limit the present disclosure. For those skilled in the art, the present disclosure may have various modifications and variations. Any modifications, equivalent substitutions, improvements, etc. made within the spirit and principles of the present disclosure shall be included within the scope of the present disclosure.

What is claimed is:

1. A detection method for measuring profile accuracy of parabolic trough reflectors, comprising following steps:
step S1, using lights emitted by a light source (5) to simulate lights emitted from a focal point of a parabolic reflector (1) to be detected, and emitting onto the parabolic reflector (1) to be detected;
step S2, measuring a shape and a position accuracy of the parabolic reflector (1) to be detected based on a deviation of a reflected light reflected by the parabolic reflector (1).

2. The detection method for measuring profile accuracy of parabolic trough reflectors according to claim 1, wherein there are at least two light sources (5), and the light sources (5) emit parallel light rays (6) that intersect at the intersection point (20) and then emitting onto the parabolic reflector surface (1) to be detected, or reverse extension lines of the parallel light rays (6) emitted by the light sources (5) intersect at the intersection point (20).

3. The detection method for measuring profile accuracy of parabolic trough reflectors according to claim 2, wherein the position relationship between the light source (5) and the parabolic reflector (1) to be detected is that a plane formed by the light source (5) and the parallel light rays (6) and a cross-sectional profile of the parabolic reflector (1) to be detected are in the same plane, and the intersection point (20) of all parallel light rays (6) coincides with the focal position of the parabolic reflector (1) to be detected.

4. The detection method for measuring profile accuracy of parabolic trough reflectors according to claim 1, wherein in step S2, the specific method for measuring the shape and the position accuracy of the parabolic reflector (1) to be detected comprises calibrating and checking the parallelism of the parallel light rays (6) reflected by the parabolic reflector (1) from the light source (5) and/or the position error of light spots formed by a projection of the parallel light rays (6), thereby measuring a position deviation and an angle deviation of the parabolic reflector (1) to be detected.

5. A detection device for measuring the profile accuracy of parabolic trough reflectors according to claim 1, comprising at least two light sources (5) for emitting parallel light rays (6) and a scale (7), the positions of the light sources (5) and the scale (7) are relatively fixed, and the parallel light rays (6) emitted by the light sources (5) are incident on the parabolic reflector (1) to be detected for reflection, forming a light spot on the scale (7).

6. The detection device for measuring the profile accuracy of parabolic trough reflectors according to claim 5, wherein the scale (7) is provided with a scale dial (71), and the scale dial (71) is provided with a scale line (711) with two-dimensional coordinate, and the number and position of the scale dial (71) correspond one-to-one with the number and position of light spots formed by parallel light rays (6) emitting on the scale (7).

7. The detection device for measuring the profile accuracy of parabolic trough reflectors according to claim 5, wherein the scale (7) is a foldable, extendable, or/and detachable structure.

8. The detection device for measuring the profile accuracy of parabolic trough reflectors according to claim 5, wherein the scale (7) adopts a scale dial (71) with a photosensitive surface, and the scale dial (71) converts the position of the light spots emitting on the surface into electrical signals.

9. The detection device for measuring the profile accuracy of parabolic trough reflectors according to claim 5, wherein a slider (8) is installed on the detection device, a sliding rail (9) is provided as a support structure on a heat collection tube bracket (4) of the parabolic reflector surface (1) to be detected, and the slider (8) on the detection device is used in conjunction with the sliding rail (9) provided on the heat collection tube bracket (4).

10. The detection device for measuring the profile accuracy of parabolic trough reflectors according to claim 9, wherein the slider (8) is adjustably installed on the scale (7) through a first adjustment bolt (10).

11. The detection device for measuring the profile accuracy of parabolic trough reflectors according to claim 9, wherein two light source supports (14) in parallel are installed on a lower end face of the scale (7), and slide adjustment seats (19) are respectively installed on inner sides of the light source supports (14), and the slider (8) is installed on the slide adjustment seat (19) through the first adjustment bolt (10).

12. The detection device for measuring the profile accuracy of parabolic trough reflectors according to claim 9, wherein two light source supports (14) in parallel are installed on a lower end face of the scale (7), a second adjustment bolt (11) is installed on the light source support (14), and the second adjustment bolt (11) abuts against the sliding rail (9).

13. The detection device for measuring the profile accuracy of parabolic trough reflectors according to claim 12, wherein the light source (5) is mounted on the light source support (14).

14. The detection device for measuring the profile accuracy of parabolic trough reflectors according to claim 12, wherein the light source support (14) is provided with a light source installation hole, and the light source (5) is installed in the light source installation hole.

15. The detection device for measuring the profile accuracy of parabolic trough reflectors according to claim 9, wherein a first identification part (13-1) is provided at a center of a lower end face of the scale (7).

16. The detection device for measuring the profile accuracy of parabolic trough reflectors according to claim 9, wherein a first identification part (13-1) is provided at a center of a lower end face of the scale (7), a positioning support (21) is installed at a lower end of the sliding rail (9), and a second identification part (13-2) corresponding to the first identification part (13-1) is installed at a center of the positioning support (21).

17. The detection device for measuring the profile accuracy of parabolic trough reflectors according to claim 15, wherein an end of the first identification part (13-1) is arc-shaped, and when used for detection, the first identification part (13-1) is in contact with an outer wall of the heat collection tube (3).

18. The detection device for measuring the profile accuracy of parabolic trough reflectors according to claim 16, wherein the first identification part (13-1) and the second identification part (13-2) are both triangles, or the first identification part (13-1) is a triangle and the second identification part (13-2) is an M-shape matching the triangle of the first identification part (13-1).

19. The detection device for measuring the profile accuracy of parabolic trough reflectors according to claim 5, wherein the light source (5) is a visible light source, an invisible light source, or an ultrasonic wave; the visible light source is purple light, blue light, green light, yellow light, orange light, red light, or visible light emitted by a laser; and the invisible light source is an infrared light source, ultraviolet light source, or X-ray.
